(19) United States
(12) Patent Application Publication
(10) Pub. No.: US 2026/0080755 A1
(43) Pub. Date: Mar. 19, 2026

(54) GAMING DEVICE WITH ADDITIONAL PRIZE AWARDS DURING HOLD AND SPIN FEATURE

(71) Applicant: Aristocrat Technologies Australia PTY Limited, North Ryde (AU)

(72) Inventors: Joshua Matos, Cordeaux Heights (AU); Antoon Visser, Coogee (AU); Karen Kendall, Toongabbie (AU); Geoffrey Richardson, Baulkham Hills (AU)

(21) Appl. No.: 18/957,395

(22) Filed: Nov. 22, 2024

(30) Foreign Application Priority Data
Sep. 17, 2024 (AU) 2024219806

(51) Int. Cl. G07F 17/34; G07F 17/32

(52) U.S. Cl. CPC G07F 17/34; G07F 17/3213; G07F 17/3258

(57) ABSTRACT

A gaming device comprises a display, a random number generator, a processor, and a memory storing instructions. When the instructions are executed by the processor, they cause the processor to: initiate a feature game in response to a trigger condition being met in respect of a base game conducted by the gaming device; conduct game instances of the feature game until an end condition is met, wherein conducting each feature game instance comprises: displaying a matrix of symbol positions on the at least one electronic display; conducting, in respect of each symbol position of the matrix of symbol positions not occupied by a held symbol, a symbol selection process; and modifying the display of the matrix of symbol positions responsive to the symbol selection process, in order to display any selected prize symbol(s) and any selected prize award symbol(s) in addition to each held symbol.

### CROSS-REFERENCE TO RELATED APPLICATION

The present application claims priority to Australian Patent Application No. 2024219806, filed Sep. 17, 2024, and entitled, “Gaming Device with Additional Prize Awards During Hold and Spin Feature.”

### FIELD

The present application relates to a gaming device, a method of operating a gaming device and a system with additional prize awards during a hold and spin feature game.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In many games, a player may qualify for secondary games or bonus rounds by attaining a certain winning combination or triggering event in the base game. Secondary games provide an opportunity to win additional game instances, credits, awards, jackpots, progressives, etc. Awards from any winning outcomes are typically added back to the credit balance and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. Upon initiation of play, the RNG randomly determines a game outcome and symbols are then selected which correspond to that outcome. Notably, some games may include an element of skill on the part of the player and are therefore not entirely random.

### SUMMARY

An example embodiment describes a gaming device comprising an electronic display, a random number generator, a processor, and a memory storing instructions. When the instructions are executed by the processor, they cause the processor to initiate a feature game in response to a trigger condition being met in respect of a base game conducted by the gaming device, conduct game instances of the feature game until an end condition is met, wherein conducting each feature game instance comprises displaying a matrix of symbol positions on the at least one electronic display, conducting, in respect of each symbol position of the matrix of symbol positions not occupied by a held symbol, a symbol selection process using (a) the random number generator, and (b) reel strips comprising prize symbols having prize values and at least one prize award symbol, modifying display of the matrix of symbol positions on the at least one electronic display responsive to the symbol selection process in order to display any selected prize symbol(s) and any selected prize award symbol(s) in addition to each held symbol, and upon the modified display of the matrix of symbol positions, including at least one new prize award symbol, making an award based on the prize value of each displayed prize symbol.

Another example embodiment describes a method of operating a gaming device comprising an electronic display, and a random number generator. The method comprises initiating a feature game in response to a trigger condition being met in respect of a base game conducted by the gaming device, conducting game instances of the feature game until an end condition is met, wherein conducting each feature game instance comprises displaying a matrix of symbol positions on the electronic display, conducting, in respect of each symbol position of the matrix of symbol positions not occupied by a held symbol, a symbol selection process using (a) the random number generator, and (b) reel strips comprising prize symbols having prize values and at least one prize award symbol, modifying display of the matrix of symbol positions on the electronic display responsive to the symbol selection process in order to display any selected prize symbol(s) and any selected prize award symbol(s) in addition to each held symbol, and upon the modified display of the matrix of symbol positions, including at least one new prize award symbol, making an award based on the prize value of each displayed prize symbol.

Another example embodiment describes a system comprising at least one electronic display, a random number generator, one or more processors, and memory storing instructions. When the instructions are executed by the one or more processors, they cause the one or more processors to initiate a feature game in response to a trigger condition being met in respect of a base game conducted by the gaming device, conduct game instances of the feature game until an end condition is met, wherein conducting each feature game instance comprises displaying a matrix of symbol positions on the at least one electronic display, conducting, in respect of each symbol position of the matrix of symbol positions not occupied by a held symbol, a symbol selection process using (a) the random number generator, and (b) reel strips comprising prize symbols having prize values and at least one prize award symbol, modifying display of the matrix of symbol positions on the at least one electronic display responsive to the symbol selection process in order to display any selected prize symbol(s) and any selected prize award symbol(s) in addition to each held symbol, and upon the modified display of the matrix of symbol positions, including at least one new prize award symbol, making an award based on the prize value of each displayed prize symbol.

### BRIEF DESCRIPTION OF THE DRAWINGS

FIG. 1 is an exemplary diagram showing several EGMs networked with various gaming related servers.

FIG. 2 is a block diagram showing various functional elements of an exemplary EGM.

FIG. 3 illustrates an example reel strip layout.

FIG. 4 is a flow chart of a symbol selection method.

FIG. 5 is a flow chart of a method of operating a gaming device.

FIGS. 6 to 15 are example screen displays.

### DETAILED DESCRIPTION

There is disclosed a gaming device, a method of operating a gaming device and a system where additional prize awards may be made during individual game instances of a hold and spin feature game where game instances are conducted until an end condition is met. In the hold and spin feature game, prize symbols having prize values are collected and held in place for subsequent game instances. An award based on the total of the prize values of collected prize symbols is made at the conclusion of the hold and spin feature game instances. In an example, an additional award based on the values of the currently displayed prize symbols is made if a prize award symbol is selected. In some examples, the prize award symbol may have a multiplier that is applied to the prize values.

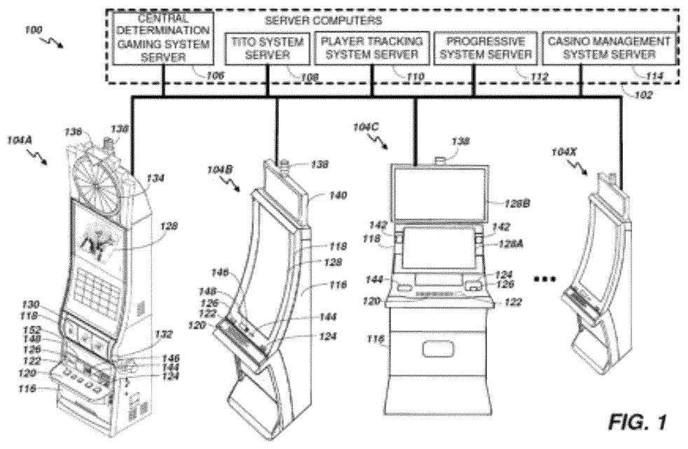

FIG. 1 illustrates several different models of EGMs which may be networked to various gaming related servers. The present invention can be configured to work as a system 100 in a gaming environment including one or more server computers 102 (e.g., slot servers of a casino) that are in communication, via a communications network, with one or more gaming devices 104A-104X (EGMs, slots, video poker, bingo machines, etc.). The gaming devices 104A-104X may alternatively be portable and/or remote gaming devices such as, but not limited to, a smart phone, a tablet, a laptop, or a game console.

Communication between the gaming devices 104A-104X and the server computers 102, and among the gaming devices 104A-104X, may be direct or indirect, such as over the Internet through a website maintained by a computer on a remote server or over an online data network including commercial online service providers, Internet service providers, private networks, and the like. In other embodiments, the gaming devices 104A-104X may communicate with one another and/or the server computers 102 over RF, cable TV, satellite links and the like.

In some embodiments, server computers 102 may not be necessary and/or preferred. For example, the present invention may, in one or more embodiments, be practiced on a stand-alone gaming device such as gaming device 104A, gaming device 104B or any of the other gaming devices 104C-104X. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door 116 which provides access to the interior of the cabinet. Gaming device 104A typically includes a button area or button deck 120 accessible by a player that is configured with input switches or buttons 122, an access channel for a bill validator 124, and/or an access channel for a ticket printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The reels 130 are independently spun and stopped to show a set of symbols within the gaming display area 118 which may be used to determine an outcome to the game. In embodiments where the reels are mechanical, mechanisms can be employed to implement greater functionality. For example, the boundaries of the gaming display area boundaries of the gaming display area 118 may be defined by one or more mechanical shutters controllable by a processor. The mechanical shutters may be controlled to open and close, to correspondingly reveal and conceal more or fewer symbol positions from the mechanical reels 130. For example, a top boundary of the gaming display area 118 may be raised by moving a corresponding mechanical shutter upwards to reveal an additional row of symbol positions on stopped mechanical reels. Further, a transparent or translucent display panel may be overlaid on the gaming display area 118 and controlled to override or supplement what is displayed on one or more of the mechanical reel(s).

In many configurations, the gaming machine 104A may have a main display 128 (e.g., video display monitor) mounted to, or above, the gaming display area 118. The main display 128 can be a high-resolution LCD, plasma, LED, or OLED panel which may be flat or curved as shown, a cathode ray tube, or other conventional electronically controlled video monitor.

In some embodiments, the bill validator 124 may also function as a “ticket-in” reader that allows the player to use a casino issued credit ticket to load credits onto the gaming device 104A (e.g., in a cashless ticket (“TITO”) system). In such cashless embodiments, the gaming device 104A may also include a “ticket-out” printer 126 for outputting a credit ticket when a “cash out” button is pressed. Cashless TITO systems are well known in the art and are used to generate and track unique bar-codes or other indicators printed on tickets to allow players to avoid the use of bills and coins by loading credits using a ticket reader and cashing out credits using a ticket-out printer 126 on the gaming device 104A. In some embodiments a ticket reader can be used which is only capable of reading tickets. In some embodiments, a different form of token can be used to store a cash value, such as a magnetic stripe card.

In some embodiments, a player tracking card reader 144, a transceiver for wireless communication with a player's smartphone, a keypad 146, and/or an illuminated display 148 for reading, receiving, entering, and/or displaying player tracking information is provided in EGM 104A. In such embodiments, a game controller within the gaming device 104A can communicate with the player tracking server system 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

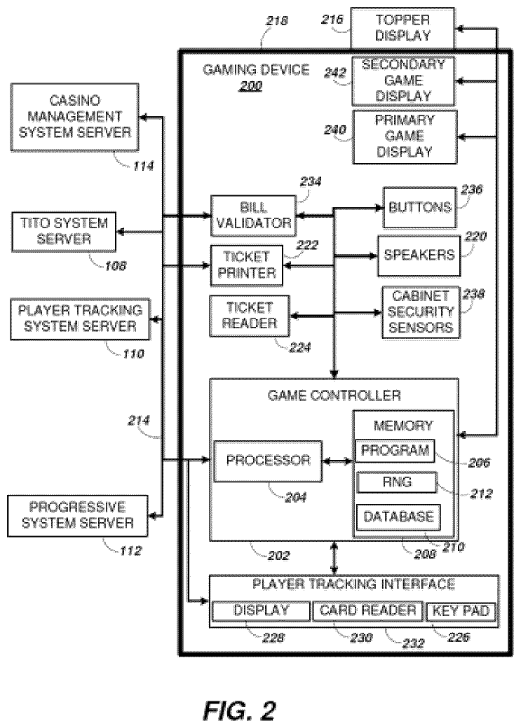

Many or all the above described components can be controlled by circuitry (e.g., a gaming controller) housed inside the main cabinet 116 of the gaming device 104A, the details of which are shown in FIG. 2.

Note that not all gaming devices suitable for implementing embodiments of the present invention necessarily include top wheels, top boxes, information panels, cashless ticket systems, and/or player tracking systems. Further, some suitable gaming devices have only a single game display that includes only a mechanical set of reels and/or a video display, while others are designed for bar counters or table tops and have displays that face upwards.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main door 118 which opens to provide access to the interior of the gaming device 104B. The main or service door 118 is typically used by service personnel to refill the ticket-out printer 126 and collect bills and tickets inserted into the bill validator 124. The door 118 may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the landscape display 128A may have a curvature radius from top to bottom, or alternatively from side to side. In some embodiments, display 128A is a flat panel display. Main display 128A is typically used for primary game play while secondary display 128B is typically used for bonus game play, to show game features or attraction activities while the game is not in play or any other information or media desired by the game designer or operator.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2 is a block diagram depicting exemplary internal electronic components of a gaming device 200 connected to various external systems. All or parts of the example gaming device 200 shown could be used to implement any one of the example gaming devices 104A-X depicted in FIG. 1. The games available for play on the gaming device 200 are controlled by a game controller 202 that includes one or more processors 204 and a game that may be stored as game software or a program 206 in a memory 208 coupled to the processor 204. The memory 208 may include one or more mass storage devices or media that are housed within gaming device 200. Within the mass storage devices and/or memory 208, one or more databases 210 may be provided for use by the program 206. A random number generator (RNG) 212 that can be implemented in hardware and/or software is typically used to generate random numbers that are used in the operation of game play to ensure that game play outcomes are random and meet regulations for a game of chance. In some embodiments, the random number generator 212 is a pseudo-random number generator.

Alternatively, a game instance (i.e. a play or round of the game) may be generated on a remote gaming device such as a central determination gaming system server 106 (not shown in FIG. 2 but see FIG. 1). The game instance is communicated to gaming device 200 via the network 214 and then displayed on gaming device 200. Gaming device 200 may execute game software, such as but not limited to video streaming software that allows the game to be displayed on gaming device 200. When a game is stored on gaming device 200, it may be loaded from a memory 208 (e.g., from a read only memory (ROM)) or from the central determination gaming system server 106 to memory 208. The memory 208 may include RAM, ROM or another form of storage media that stores instructions for execution by the processor 204.

The gaming device 200 may include a topper display 216 or another form of a top box (e.g., a topper wheel, a topper screen, etc.) which sits above main cabinet 218. The gaming cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. The player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. Ticket printer 222 may be used to print tickets for a TITO system server 108. The gaming device 200 may further include a bill validator 234, buttons 236 for player input, cabinet security sensors 238 to detect unauthorized opening of the cabinet 218, a primary game display 240, and a secondary game display 242, each coupled to and operable under the control of game controller 202.

Gaming device 200 may be connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

Gaming devices, such as gaming devices 104A-104X, 200, are highly regulated to ensure fairness and, in many cases, gaming devices 104A-104X, 200 are operable to award monetary awards (e.g., typically dispensed in the form of a redeemable voucher). Therefore, to satisfy security and regulatory requirements in a gaming environment, hardware and software architectures are implemented in gaming devices 104A-104X, 200 that differ significantly from those of general-purpose computers. Adapting general purpose computers to function as gaming devices 200 is not simple or straightforward because of: 1) the regulatory requirements for gaming devices 200, 2) the harsh environment in which gaming devices 200 operate, 3) security requirements, 4) fault tolerance requirements, and 5) the requirement for additional special purpose componentry enabling functionality of an EGM. These differences require substantial engineering effort with respect to game design implementation, hardware components and software.

When a player wishes to play the gaming device 200, he/she can insert cash or a ticket voucher through a credit input mechanism such as a coin acceptor (not shown) or bill validator 234 to establish a credit balance on the gamine machine. The credit balance is used by the player to place wagers on instances of the game and to receive credit awards based on the outcome of winning instances. The credit balance is decreased by the amount of each wager and increased upon a win. The player can add additional credits to the balance at any time. The credit balance may be stored in a meter in memory 208 (or in a separate hardware meter). In some embodiment, memory 208 implements a credit meter to monitor to the credit balance and has a win meter that monitors any amounts won during any game instance(s) resulting from the wager. The balance of the win meter is transferred to the credit meter prior at the conclusion of the game instances. The player may also optionally insert a loyalty club card into the card reader 230. In some embodiments, the loyalty club card may also act as a credit input mechanism, by allowing a player to transfer funds from a centrally stored balance in order to establish a credit balance. During the game, the player views the game outcome on the game displays 240, 242. Other game and prize information may also be displayed.

When the player is done, he/she cashes out the credit balance (typically by pressing a cash out button to receive a ticket from the ticket printer 222). The ticket may be “cashed-in” for money or inserted into another machine to establish a credit balance for play.

An example method of operating an EGM broadly involves conducting a base game in response to receipt of a wager by selecting symbols from reel strips, evaluating the selected symbols, and conducting a feature game if one is triggered.

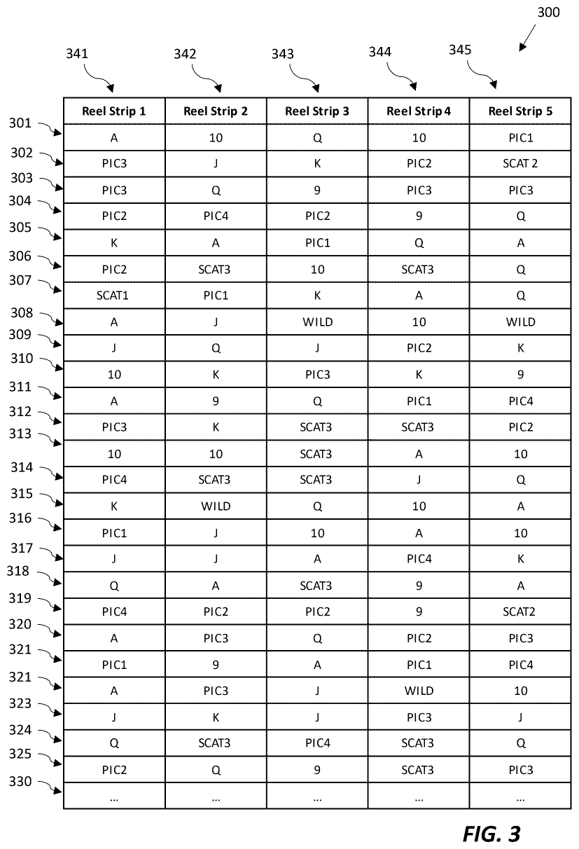

FIG. 3 shows example reel strips that illustrate the make-up of reel strips used in the base game. FIG. 3 illustrates an example of a set 300 of five reel strips 341, 342, 343, 344, 345. In the example, for illustrative purposes, twenty-five reel strip positions 301-325 are shown for each reel strip 341-345. Each reel strip position of each reel has a symbol. For example, a “PIC1” symbol occupies the twenty-first reel strip position 321 of the fourth reel 344. The symbols shown on the reel strip are generally indicative of symbols that may be employed in the embodiments, however, other reels strips to those illustrated in FIG. 3 can be used, for example, reel strips where two or more wild symbols are placed at consecutive reel strip positions of a reel strip. Symbol position 330 indicates that the reel strips 341-345 may have more symbols than illustrated. For example, the reel strips 341-345 could have between 30 and 100 reel strip positions with the last reel strip position of a respective reel strip being treated as contiguous with the first reel strip position 301 as would be the case with a mechanical reel. The actual lengths of the game reel strips depend on factors such as the lengths of the stacks, the number of wild symbols (in general, the more wilds there are, the longer the reel strip needs to be), and volatility (in general, the higher the prize value is, the longer the reel strip needs to be to lower the hit rate). In some examples, the reel strips associated with different columns may be of different lengths to one another. In this example, the reel strips include three different scatter (SCAT) symbols which form part of the trigger mechanism for a hold and spin feature game of an embodiment as described in further detail below. The visual representation of the scatter symbols may be linked to a theme of the game.

In this example, the symbols of the first reel strip 341 include a SCAT 1 symbol 631 at reel strip position 307.

In this example, the fifth reel strip comprises another SCAT symbol, here SCAT2 symbol, shown, for example, at second reel strip position 302 of fifth reel strip 345.

In this example, reel strips 341-343 have SCAT3 symbols (e.g. at the sixth reel strip position 306 of second reel strip 342). As described further below, SCAT3 symbols are independently configured in each game instance to have one of a credit prize symbol (e.g. a credit value), a bonus prize symbol (e.g. Mini Bonus, Minor Bonus), or jackpot prize symbol (e.g. Major Jackpot, Grand Jackpot). Accordingly, the SCAT3 symbols can be understood to be prize symbols as they carry a prize, and are sometimes referred to as “Cash on Reel”symbols (CORs).

In this example, another component of the trigger mechanism is that SCAT 3 symbols are required to be selected from the second to fourth reel strips. That is, a hold and spin feature game will be triggered if SCAT1 is selected from the first reel strip 341, SCAT3 is selected from each of second to fourth reel strips 342-344, and SCAT2 is selected from the fifth reel strip 345.

It will be appreciated that in other examples, the same trigger symbol may be used for each reel strip, and that the trigger condition may be a defined minimum number of trigger symbols being selected.

In this example, during display of the selected symbols after they are selected, the reel strips are stopped from left to right, such that appearance of SCAT1 on the first reel strip, provides a visual indicator that a pre-condition for triggering a feature game has occurred.

In this example, SCAT2 symbol is used on the fifth reel strip 345 to indicate what feature game will be triggered if all other conditions are met. In an example, another SCAT symbol may be present on the fifth reel (not shown), such that it's selection from the fifth reel strip will result in a different feature game being triggered to the hold and spin feature game described below.

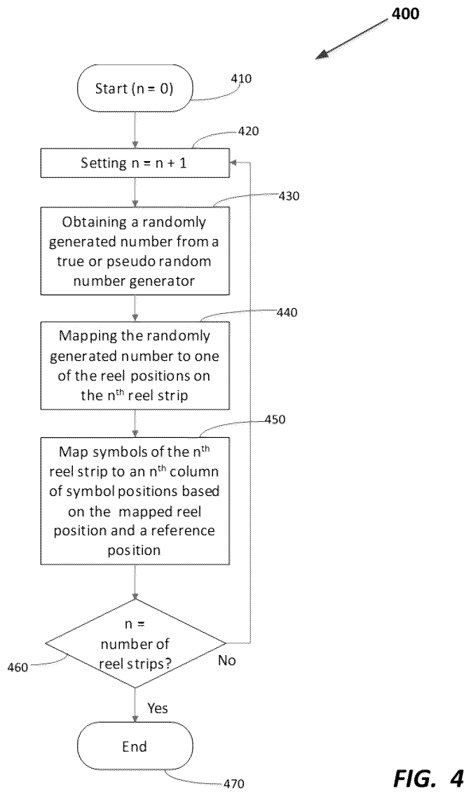

FIG. 4 is a flow chart of a general form of an example method 400 carried out by processor 204 to select symbols from r reel strips for r columns of a matrix of symbol positions—for example, five reel strips/columns.

In the example method shown in FIG. 4, at step 410, processor 204 starts the process of selecting symbols with a counter (n) set at zero as symbols have not yet been selected from any reel strips. At step 420, the processor 204 increments the counter. In the first iteration, the counter is set to 1 to reflect that symbols are to be selected from a first reel strip. At step 430, the processor obtains a randomly generated number from a true or pseudo random number generator 212. At step 440 the processor maps the generated number to one of the reel positions of the nth reel strip. In the first iteration, this is the first reel strip. To map the generated number to one of the reel positions, the possible values that can be returned from the RNG 212 are divided into ranges and associated with specific ones of the reel positions in memory 208. In one example, these ranges are stored as a look-up table. In one example, the ranges are each the same size so that each of the reel strip positions has the same chance of been selected. In other examples, the ranges may be arranged to weight the relative chances of selecting specific reel strip positions.

At step 450, processor 204 maps symbols of the nth reel strip to an nth column of symbol display positions based on the mapped reel position and a reference position. In an example, the reference position is the bottom position of the symbol positions of each column of symbol positions. Thus, in this example, the selected reel position (and hence the symbol at this position) is mapped to the bottom symbol position of the column and reel positions “above” the selected reel positions are mapped to symbol positions above the bottom symbol position in order to populate all symbol positions of the column. Referring to the example reel strips of FIG. 3, if the value returned by the RNG 212 is mapped to reel position 313 when, as in this example, four symbols are being selected for a first column of symbol positions then for the first reel strip 341, “10” is mapped to a first, bottom symbol position, “PIC3” symbol is mapped to a second symbol position, “A” symbol is mapped to a third symbol position, and “10”symbol is mapped to a fourth, top symbol position.

At step 460, the processor 460 determines whether symbols have been selected for all of the reel strips, and if not the processor 204 reverts to step 420 and iterates through steps 430, 440 and 450 until it is determined at step 460 that symbols have been selected from all n reel strips and mapped to all n columns of symbol positions after which the symbol selection process ends 470.

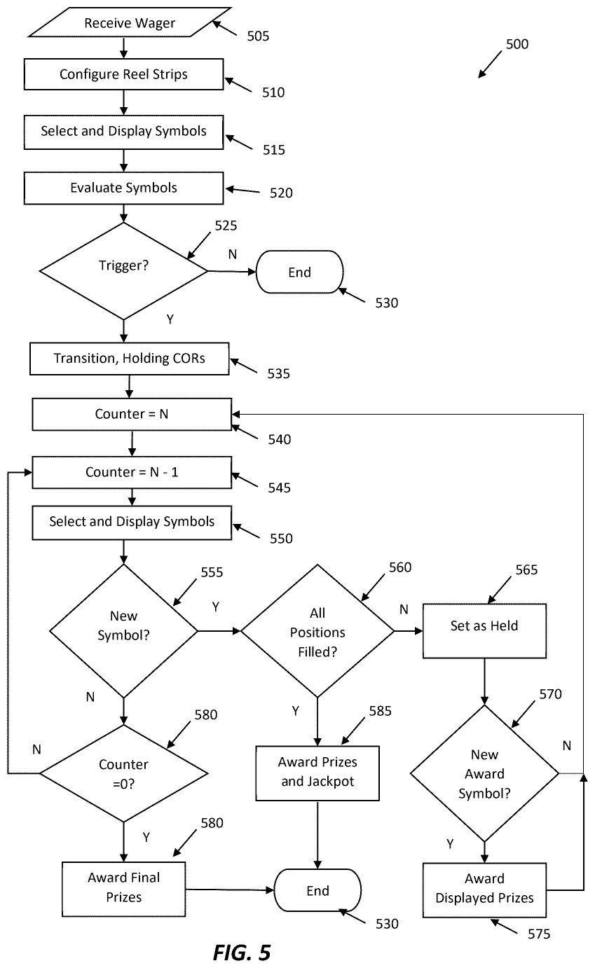

FIG. 5 is a flow chart of an example embodiment of a method 500 of operating a gaming device 200. At step 505, processor 204 initiates a base game instance in response to receiving a wager.

At step 510, processor 204 configures the reel strips for a current game instance. As indicated above, SCAT3 symbols are independently configured in each game instance to have one of a credit prize symbol (e.g. a credit value), a bonus prize symbol (e.g. Mini Bonus, Minor Bonus), or jackpot prize symbol (e.g. Major Jackpot, Grand Jackpot). In the configuration step 510, processor 204 uses random number generator 212 and a weight table in memory 208 to determine which of these symbols will be selected for a respective SCAT3 symbol position on the reel strips 341-342.

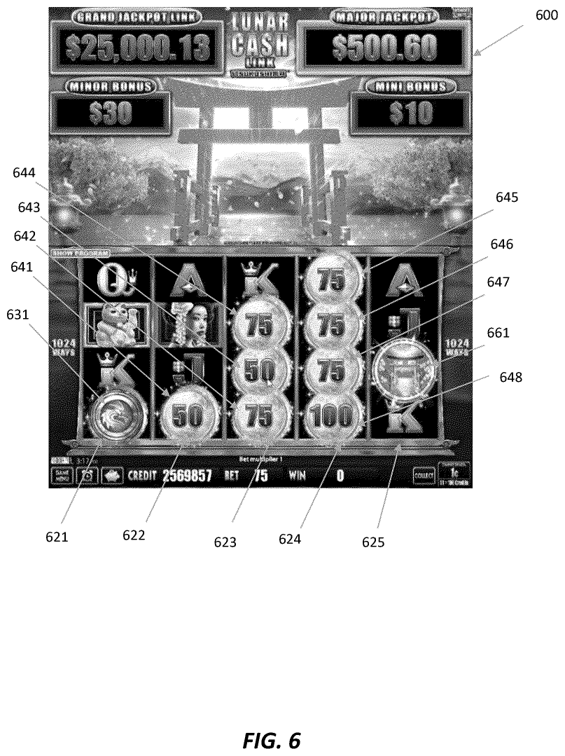

At step 515, processor 204 selects symbols from the reel strips 341-245 using the process outlined above in connection with FIG. 4 and controls the display 240 to display the selected symbols at respective symbol positions. FIG. 6 shows an example screen display 600 of an example of symbol selection for a base game, where symbols are selected for a matrix of symbol positions comprising four symbol positions in each of five columns column 621-625. In this example, the symbols selected by processor 204 include SCAT1 symbol 631 (here in the form of a dragon symbol) which has been selected in first column 621, eight SCAT3 symbols 641-648 configured with prize values which have been selected in each of second to fourth columns 622-624, and SCAT2 symbol 661 (here in the form of a gate symbol) which has been selected in fifth column 625.

At step 520, the processor 204 evaluates the selected symbols for winning symbol combinations based on a pay table defined in the memory 208. In this example, the processor 204 applies a ways to win evaluation in which winning combinations are evaluated from the left column to the right column with all symbols of a selected column evaluated and a defined symbol position of other column activated. If a player selects all the columns as part of the wager, there are 1024 ways to win.

At step 525, processor 204 determines whether a trigger condition is met in respect of the base game. If a trigger condition is not met, the game ends 530.

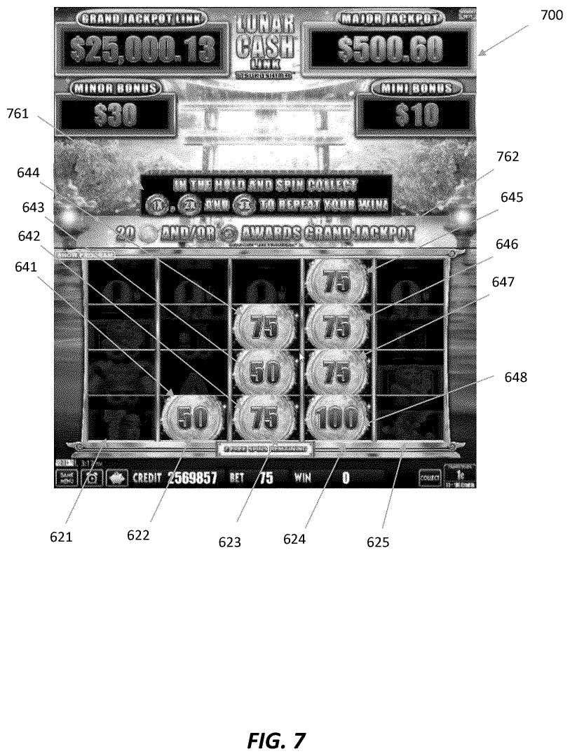

In the example of screen display 600, processor 204 will make a positive determination at step 525 as the selected symbols satisfy the trigger condition set out above. Accordingly, processor 204 proceeds to step 535 and transitions to a hold and spin feature game display, holding the prize symbols (CORs) selected in the base game in place for the hold and spin feature game. FIG. 7 is an example screen display 700 of a hold and spin feature game following such a transition from which it will be apparent that the eight prize symbols 341-348 have been held from the triggering combination in the base game. The remaining symbol positions are greyed-out to indicate that they are not occupied by a held symbol. In other examples, no symbols are held from the base game.

During the feature game, processor 204 carries out a symbol selection process for each symbol position not occupied by a held symbol as described in further detail below. Screen display 700 includes a first game message 761 “In the hold and spin [feature] collect 1X, 2X and 3X [prize award symbols] to repeat your win”. In this context, “repeat” indicates an additional award made during the hold and spin feature game instances that is in addition to an award made at the end of the hold and spin game instances as described in further detail below. Second game message 762 “20 [prize symbols] and/or [prize award symbols] awards Grand Jackpot”. The first game message 761 indicates that the prize award symbols result in an advantageous additional prize award during the hold and spin feature game as described in further detail below.

At step 540, processor 204 sets a hold and spin game counter to an initial number (N) that defines a minimum number of hold and spin game instances to be conducted. In an example, N=3.

At step 545, processor 204 initiates a hold and spin game instances (e.g. in response to a player pressing a play button) and decrements the counter by one.

At step 550, the processor 204 configures the feature game reel strips, associates reel strips with individual symbol positions, selects stopping positions for reel strips, and controls the display 240 to display any selected prize or prize award symbols.

In this respect, the reel strips employed in the feature game differ from those of the base game. In an example, there are 17 reel strips in the set of reel strips, corresponding to the maximum possible number of symbol positions that are not occupied by a held symbol at the start of the feature game. In an example, each reel strip comprises at least one, and generally more than one, prize symbol and/or prize award symbol. The remaining symbol positions are occupied by “blank” symbols or treated as blank in the sense that they do not form part of game outcomes of the game. In some examples, the blank symbols are other game symbols corresponding to the theme of the game but are displayed as greyed out when the reel strips are displayed as spinning by the processor 204 and if they land at a symbol position.

In an example, the prize award symbols are either 1X, 2X, or 3X prize award symbols. In an example, prize symbol positions on the reel strips are configured in each game instance by processor 204 randomly selecting prize values using a weighted table stored in memory. In an alternative example, the reel strips are configured once at the start of the hold and spin feature game.

Processor 204 then uses RNG 212 to randomly select a reel strip to be associated with each empty symbol position. In an example, processor 204 first associates a jackpot control reel strip of the set of reel strips with a symbol position. In an example, a jackpot control reel strip is used to control the probability of a Grand Jackpot prize being awarded for twenty prize/prize award symbols being selected.

The jackpot control reel strip may have a large number of reel strip positions and a small number of prize/prize award symbols (e.g. 1) linked to the desired hit rate for awarding the Grand Jackpot prize. As the jackpot control reel strip is always associated with a symbol position, the relatively low odds of a prize/prize award symbol being selected will control the probability of a twentieth prize/prize award symbol being selected should the hold and spin feature game progress that far, hence controlling the probability of the Grand Jackpot being awarded. Processor 204 then associates other reel strips of the set of reel strips with each other unoccupied symbol positions.

Processor 204 then determines stopping positions for each of the reel strips using a modified version of the process of FIG. 4 where a single reel strip position is mapped to the relevant symbol position, resulting in display of one of a prize symbol, prize award symbol, or blank/greyed out symbol.

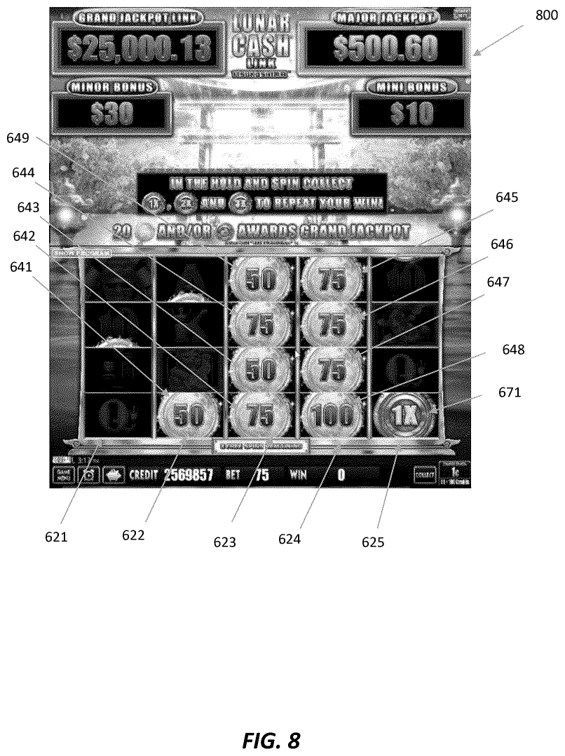

FIG. 8 is an example screen display 800 after such a selection. In this example, an additional prize symbol 649 and a first prize award symbol 671 have been selected by the processor 204.

At step 555, processor 204 determines whether a new symbol has been selected at step 550. If processor makes a negative determination at step 55, processor 204 determines whether the counter has reached zero at step 580. The counter reaching zero is one of two end conditions for ending the hold and spin feature game and processor 204 conducts game instances until an end condition is met. Accordingly, if the processor 204 makes a positive determination at step 580, the game ends 530. If processor 204 makes a negative determination at step 580, processor 203 proceeds to step 545 and conducts another game instance In the example of screen display 800, processor 204 will make a positive determination at step 555 due to the selection of additional prize symbol 649 and first prize award symbol 671. Accordingly, processor 204 proceeds to step 560 and determines whether all symbol positions are filled by prize symbols or prize award symbols. All symbol positions being filled is the second end condition and results in the processor 204 awarding all displayed prizes and the Grand Jackpot prize at step 585 before the game ends.

In the example of screen display 800, processor 204 will make a negative determination at step 560 and proceed to step 565 where additional prize symbol 649 and first prize award symbol 671 are set as to be held for the next hold and spin game instance.

At step 570, processor 204 determines whether there is a new prize award symbol—a prize award symbol that has previously been used to award displayed prizes. In the case of FIG. 8, processor 204 will make a positive determination at step 570 and proceed to step 575.

At step 575, processor 204 makes an award based on the displayed values and the value of the prize award symbol. In this example, the prize award symbols indicated how many times the prize values will be awarded, here one times (1X), two times (2X) or three times (3X) the prize values. In other examples, prize award symbols can take different forms, particularly if none of the prize award symbols have an associated multiplier. Where a prize award symbol has a multiplier (e.g. 2X, 3X), the total prize awarded at step 575 corresponds to the value of the prize symbols multiplied by the multiplier. It will also be appreciated that other multipliers may be used.

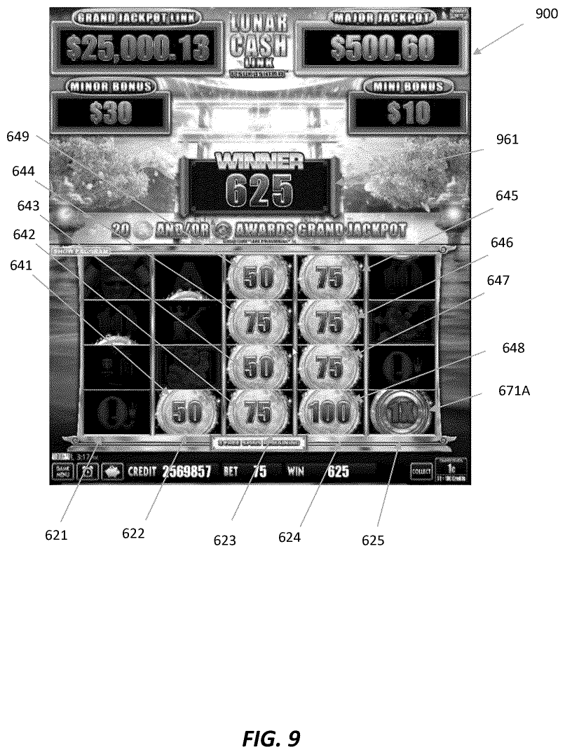

In the example of screen display 800, processor 204 makes an award at step 575 of (50+50+75+50+75+75+75+75+100)×1=625 credits as shown by prize award message 961 in example screen display 900 of FIG. 9. It will also be observed that in FIG. 9, processor 204 has modified display of first prize award symbol 671A on display 240 by greying out the multiplier to indicate a used prize award symbol. Following step 575 (or making a negative determination at step 570, processor reverts to step 540 and resets the counter to N (here 3) before conducting a further game instance. In this way, the end condition for the hold and spin game instances, requires that three game instances in a row be conducted without selecting a new prize or prize award symbol.

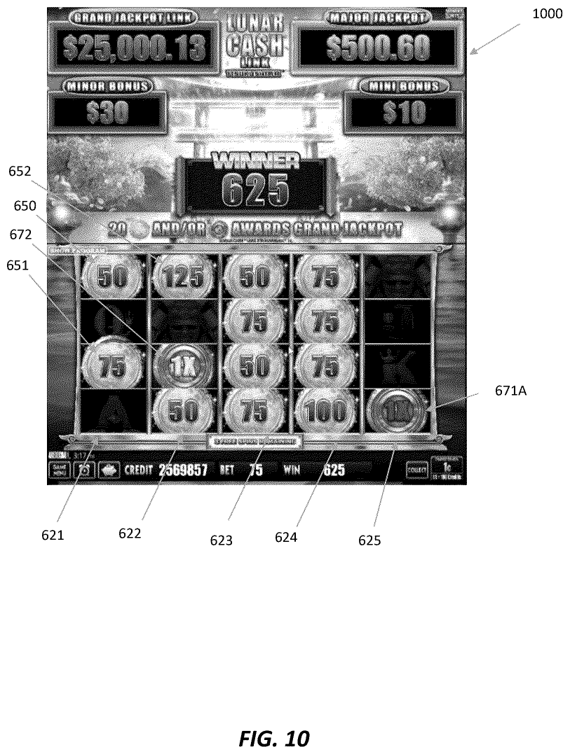

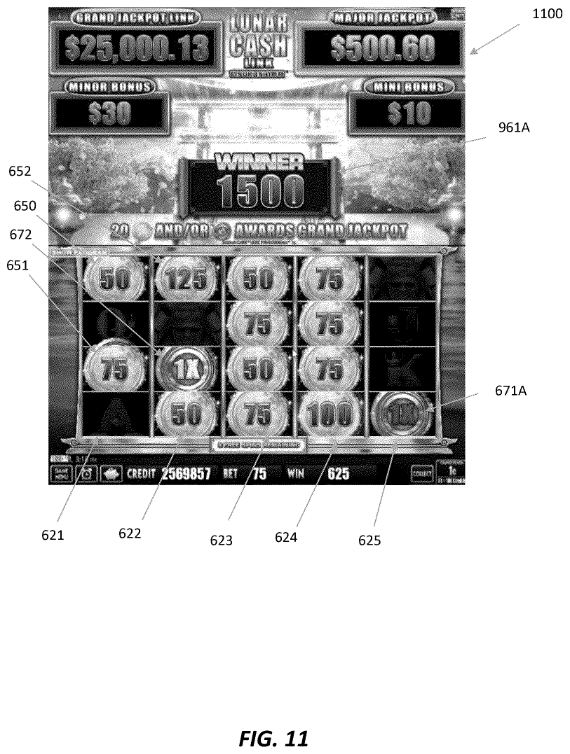

FIG. 10 is an example screen display 1000 of a subsequent game instance where three further prize symbols 650-652 and a second 1X prize award symbol 672 have been selected. Accordingly, screen display 1000 will result in positive determinations at steps 555 and 570 such that processor 204 conducts step 575. In the example of FIG. 10, processor 204 makes an award of (50+50+75+50+75+75+75+75+100+50+75+125)×1=875 credits. Processor 204 makes the award by updating prize award display 961A to 625+875=1500 credits as shown in example screen display 1100 of FIG. 11.

As may now be appreciated, according to some embodiments, as soon as a multiplier lands, it may be accumulated in the game counter, e.g., as described above with reference to symbol 671A indicated as a “used” symbol. Because of this unique programming feature, the multiplier value will only be applied to CORs that are already displayed. Subsequent CORs, i.e., those that land afterwards, for example the symbols 650-652 in FIG. 10, are not multiplied by multiplier 671. As described in FIG. 10, a new multiplier 672 may also land, which may then be applied to all the CORs currently displayed. This functionality is unique, at least in part, because it occurs while the feature game is still in play (i.e., the technical challenge faced in previous designs is overcome by pausing the feature game to accumulate the multiplier, and then the feature game is permitted to continue, only once all the newly-landed prize symbols have been accounted for).

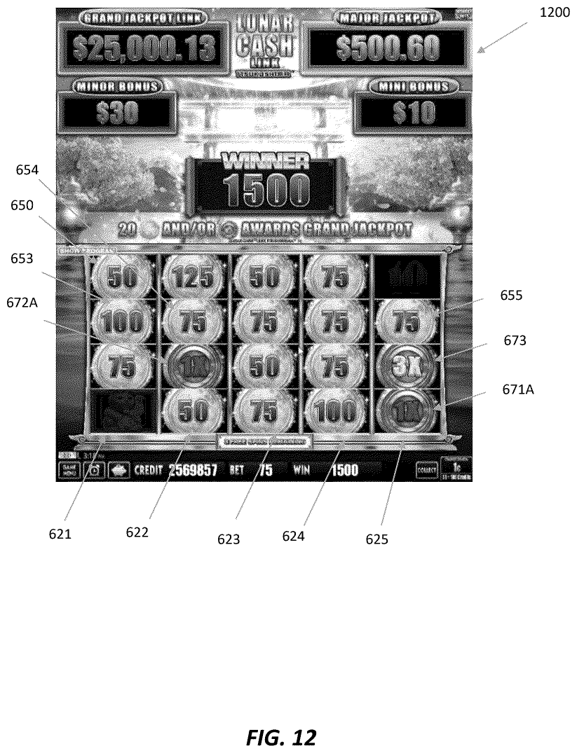

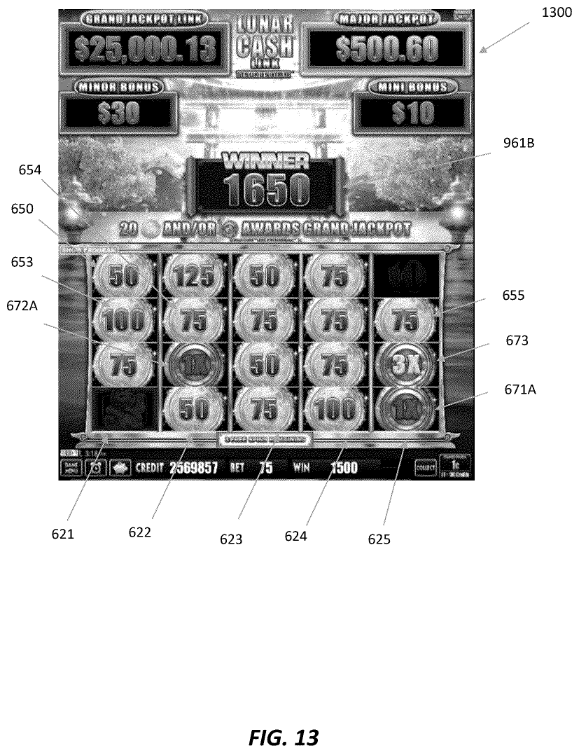

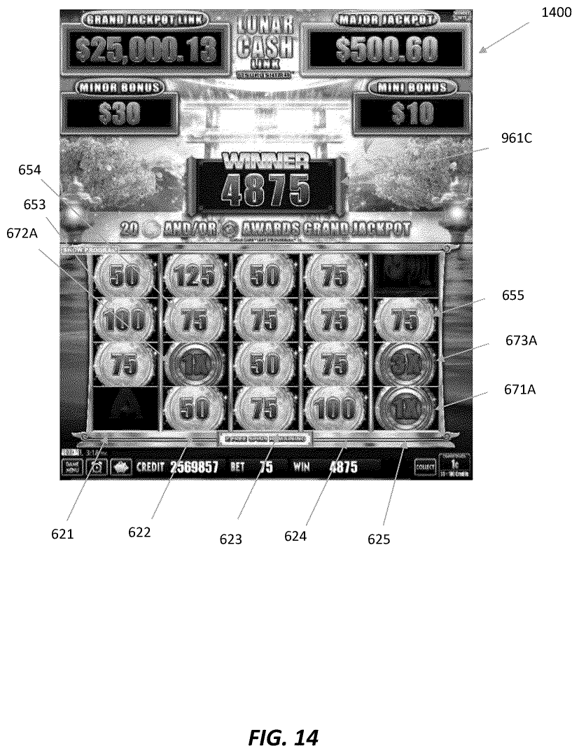

FIG. 12 is an example screen display 1200 of a subsequent game instance where three further prize symbols 653-655 and a third prize award symbol 673 have been selected. In this example, third prize award symbol 673 has a X3 multiplier. It will be observed that second prize award symbol 672A has now been modified such that the X1 multiplier is greyed out to indicate that it has previously been awarded. Screen display 1200 will also result in processor 240 making positive determinations at steps 555 and 570 such that processor 204 will again conducts step 575. In the example of FIG. 12, processor 204 makes an award of (50+50+75+50+75+75+75+75+100+50+75+125+100+75+75)×3=3375 credits. Processor 204 makes the award by updating prize award display 961C to 625+875+3375=4875 credits as shown in example screen display 1400 of FIG. 14. As shown by FIG. 13, in some examples, processor 204 updates the prize award display 961 individually for each prize symbol. FIG. 13 is an example screen display 1300 following FIG. 12, where processor 204 has updated the prize award display 961B by awarding three times the value shown on the top prize symbol 650 of the first column 621. In an example, the processor 204 updates the prize award display 961 from top to bottom of each column 621-625, working from the left most column 621 to the right.

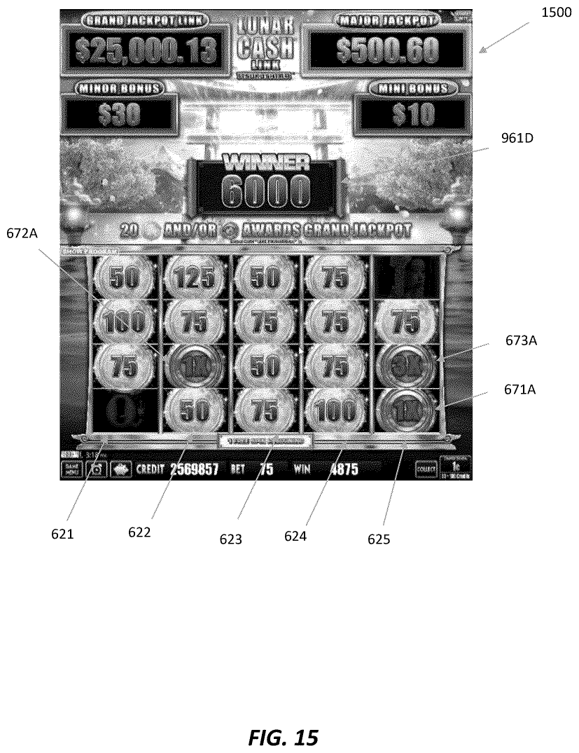

As indicated above, unless a Grand Jackpot is awarded, eventually processor 204 will make a negative determination at step 580. FIG. 15 shows an example screen display 4500 following such a determination. It will be observed that third prize award symbol 673A has now been modified such that the X3 multiplier is greyed out to indicate that it has previously been awarded. Accordingly, in this example processor 204 will proceed to step 580 and make a final award of credits based on the values of the displayed prize symbols. Here the values total 1125 credits and accordingly processor 204 updates prize award display 961D to 4875+1125=6000 credits following which processor 204 ends the game 530.

It will be appreciated that the above examples advantageously allow the award of additional prizes during the hold and spin game instances while still allowing a prize award at the conclusion of the hold and spin game instances and providing an opportunity for an additional award to be made in respect of all symbol positions being filled, here the Grand Jackpot prize.

The invention may also be said broadly to consist in the parts, elements and features referred to or indicated in the specification of the application, individually or collectively, in any or all combinations of two or more of said parts, elements or features.

In the above examples, the prize award symbols are held for all subsequent game instances. In an alternative example, after the prize award symbols are redeemed, processor 204 modifies the prize award symbols to be prize symbols.

Although the invention has been described by way of example, it should be appreciated that variations and modifications may be made without departing from the scope of the invention as defined in the claims. Furthermore, where known equivalents exist to specific features, such equivalents are incorporated as if specifically referred in this specification.

What is claimed is:

1. A gaming device comprising:
an electronic display;
a random number generator;
a processor; and
a memory storing instructions which, when executed by the processor, cause the processor to:
initiate a feature game in response to a trigger condition being met in a base game conducted by the gaming device; and
conduct game instances of the feature game until an end condition is met, wherein conducting each feature game instance comprises:
displaying a matrix of symbol positions on the electronic display;
conducting, in respect of each symbol position of the matrix of symbol positions not occupied by a held symbol, a symbol selection process using: (a) the random number generator; and (b) reel strips comprising prize symbols having prize values and at least one prize award symbol;
modifying display of the matrix of symbol positions on the electronic display responsive to the symbol selection process, in order to display any selected prize symbol(s) and any selected prize award symbol(s) in addition to each held symbol; and
upon the modified display of the matrix of symbol positions, including at least one new prize award symbol, making an award based on the prize value of each displayed prize symbol.

2. The gaming device as claimed in claim 1, wherein the reel strips include at least one prize award symbol having a multiplier, and, when the instructions are executed by the processor, they further cause the processor to: upon the modified display of the matrix of symbol positions including a new prize award symbol having a multiplier, make an award based on a value of the multiplier and the prize value of each displayed prize symbol, such that a multiple of the total of the prize award symbols is awarded.

3. The gaming device as claimed in claim 1, wherein the reel strips include at least one prize award symbol having no multiplier, and, when the instructions are executed by the processor, they further cause the processor to: upon the modified display of the matrix of symbol positions including a new prize award symbol having no multiplier, make an award of the prize value of each displayed prize symbol, such that the total of the prize award symbols is awarded.

4. The gaming device as claimed in claim 1, wherein the reel strips include at least one prize award symbol having a one times multiplier, and, when the instructions are executed by the processor, they further cause the processor to: upon the modified display of the matrix of symbol positions including a new prize award symbol having a one times multiplier, make an award of the prize value of each displayed prize symbol, such that the total of the prize award symbols is awarded.

5. The gaming device as claimed in claim 1, wherein, when the instructions are executed by the processor, they further cause the processor to hold each symbol displayed in the modified display of the matrix of symbol positions for any subsequent game instance.

6. The gaming device as claimed in claim 1, wherein, when the instructions are executed by the processor, they further cause the processor to make an award of the total of the prize award symbols when an end condition is met.

7. The gaming device as claimed in claim 1, wherein the end condition comprises at least one of:
a defined number of game instances being conducted without at least one of a new prize award symbol and a new prize symbol being selected; or
all of the symbol positions of the matrix being occupied by a new prize award symbol or a new prize symbol being selected.

8. A method of operating a gaming device comprising an electronic display and a random number generator, the method comprising:
initiating a feature game in response to a trigger condition being met in respect of a base game conducted by the gaming device; and
conducting game instances of the feature game until an end condition is met, wherein conducting each feature game instance comprises:
displaying a matrix of symbol positions on the electronic display;
conducting, in respect of each symbol position of the matrix of symbol positions not occupied by a held symbol, a symbol selection process using: (a) the random number generator' and (b) reel strips comprising prize symbols having prize values and at least one prize award symbol;
modifying display of the matrix of symbol positions on the electronic display responsive to the symbol selection process, in order to display any selected prize symbol(s) and any selected prize award symbol(s) in addition to each held symbol; and
upon the modified display of the matrix of symbol positions, including at least one new prize award symbol, making an award based on the prize value of each displayed prize symbol.

9. The method as claimed in claim 8, wherein the reel strips include at least one prize award symbol having a multiplier, and upon the modified display of the matrix of symbol positions including a new prize award symbol having a multiplier, the method further comprises: making an award based on a value of the multiplier and the prize value of each displayed prize symbol, such that a multiple of the total of the prize award symbols is awarded.

10. The method as claimed in claim 8, wherein the reel strips include at least one prize award symbol having no multiplier, and upon the modified display of the matrix of symbol positions including a new prize award symbol having no multiplier, the method further comprises: making an award of the prize value of each displayed prize symbol, such that the total of the prize award symbols is awarded.

11. The method as claimed in claim 8, wherein the reel strips include at least one prize award symbol having a one times multiplier, and upon the modified display of the matrix of symbol positions including a new prize award symbol having a one times multiplier, the method further comprises: making an award of the prize value of each displayed prize symbol, such that the total of the prize award symbols is awarded.

12. The method as claimed in claim 8, further comprising: holding each symbol displayed in the modified display of the matrix of symbol positions for any subsequent game instance.

13. The method as claimed in claim 8, further comprising: making an award of the total of the prize award symbols when an end condition is met.

14. A system comprising:
at least one electronic display;
a random number generator;
one or more processors; and
memory storing instructions which, when executed by the one or more processors, cause the one or more processors to:
initiate a feature game in response to a trigger condition being met in respect of a base game conducted by the gaming device; and
conduct game instances of the feature game until an end condition is met, wherein conducting each feature game instance comprises:
displaying a matrix of symbol positions on the at least one electronic display;
conducting, in respect of each symbol position of the matrix of symbol positions not occupied by a held symbol, a symbol selection process using: (a) the random number generator; and (b) reel strips comprising prize symbols having prize values and at least one prize award symbol;
modifying display of the matrix of symbol positions on the at least one electronic display responsive to the symbol selection process, in order to display any selected prize symbol(s) and any selected prize award symbol(s) in addition to each held symbol; and
upon the modified display of the matrix of symbol positions, including at least one new prize award symbol, making an award based on the prize value of each displayed prize symbol.

15. The system as claimed in claim 14, wherein the reel strips include at least one prize award symbol having a multiplier, and when the instructions are executed by the one or more processors, they further cause the one or more processors to: upon the modified display of the matrix of symbol positions including a new prize award symbol having a multiplier, make an award based on a value of the multiplier and the prize value of each displayed prize symbol, such that a multiple of the total of the prize award symbols is awarded.

16. The system as claimed in claim 14, wherein the reel strips include at least one prize award symbol having no multiplier, and when the instructions are executed by the one or more processors, they further cause the one or more processors to: upon the modified display of the matrix of symbol positions including a new prize award symbol having no multiplier, make an award of the prize value of each displayed prize symbol, such that the total of the prize award symbols is awarded.

17. The system as claimed in claim 14, wherein the reel strips include at least one prize award symbol having a one times multiplier, and when the instructions are executed by the one or more processors, they further cause the one or more processors to: upon the modified display of the matrix of symbol positions including a new prize award symbol having a one times multiplier, make an award of the prize value of each displayed prize symbol, such that the total of the prize award symbols is awarded.

18. The system as claimed in claim 14, wherein, when the instructions are executed by the one or more processors, they further cause the one or more processors to: hold each symbol displayed in the modified display of the matrix of symbol positions for any subsequent game instance.

19. The system as claimed in claim 14, wherein, when the instructions are executed by the one or more processors, they further cause the one or more processors to: make an award of the total of the prize award symbols when an end condition is met.

20. The system as claimed in claim 14, wherein the end condition comprises at least one of:
a defined number of game instances being conducted without at least one of a new prize award symbol and a new prize symbol being selected; or
all of the symbol positions of the matrix being occupied by a new prize award symbol or a new prize symbol being selected.
